(19) United States
(12) Patent Application Publication
(10) Pub. No.: US 2010/0101520 A1
(43) Pub. Date: Apr. 29, 2010

(54) Spark plug boot

(76) Inventors: Luis Arturo Arroyo, Cd. Juarez (MX); Edgar Hernandez, Cd. Juarez (MX)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/290,342

(22) Filed: Oct. 29, 2008

(51) Int. Cl. H01T 13/08

(52) U.S. Cl. 123/169 P

(57) ABSTRACT

A spark plug boot has a hollow resilient body defining an interior configured to hold a spark plug. At least one sealing ring circumscribes the outer surface of the body and is configured for being closely received in a spark plug well of an engine block. The ring defines a constant diameter around a 360 degree circumference and a variable thickness in a dimension parallel to the axis of the ring.

### FIELD OF THE INVENTION

The present invention relates generally to spark plug boots.

### BACKGROUND OF THE INVENTION

Spark plug boots are insulative hollow flexible holders into which spark plugs are inserted. The boots themselves are inserted into spark plug wells defined by the engine block. A boot should tightly seal with the spark plug inside and also with the exterior well for a variety of purposes, including but not limited to reducing engine vibration transmission to the spark plug.

To provide a tight seal with the well, many boots are formed with one or more radial rings that tightly engage the well wall. As understood herein, it can be difficult to insert a boot into a well owing to the tight fit.

### SUMMARY OF THE INVENTION

A spark plug boot has a hollow resilient body defining an interior configured to hold a spark plug. At least one sealing ring circumscribes the outer surface of the body and is configured for being closely received in a spark plug well of an engine block. The ring defines a constant diameter around a 360 degree circumference and a variable thickness in a dimension parallel to the axis of the ring.

In some embodiments at least two rings can be used, and the body can be made of Silicon. Each ring may include plural thicker portions separated by respective thinner portions. The thicker portions may be hollow or solid.

In another aspect, a spark plug boot includes an elongated body configured to hold a spark plug and as least one sealing ring circumscribing an outer surface of the body. The ring defines a first thickness and a second thickness different from the first thickness.

In another aspect, a method includes establishing at least one thin ring portion on a spark plug boot in accordance with a predetermined maximum insertion threshold. The method also includes establishing at least one thick ring portion on the boot to inhibit transmission of vibration across the boot to a spark plug held therein.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a side elevational view showing a spark plug boot in an engine well, holding a spark plug, with portions of the engine block broken away for clarity;

FIG. 2 is a perspective view of an example embodiment of the spark plug boot;

FIG. 3 is a side elevational view of the boot shown in FIG. 2, with portions broken away;

FIG. 4 is detail of the rings as seen in the circle “4” in FIG. 3; and

FIG. 5 is a side view of an alternate embodiment showing solid thicker parts.

### DETAILED DESCRIPTION OF THE PREFERRED EMBODIMENT

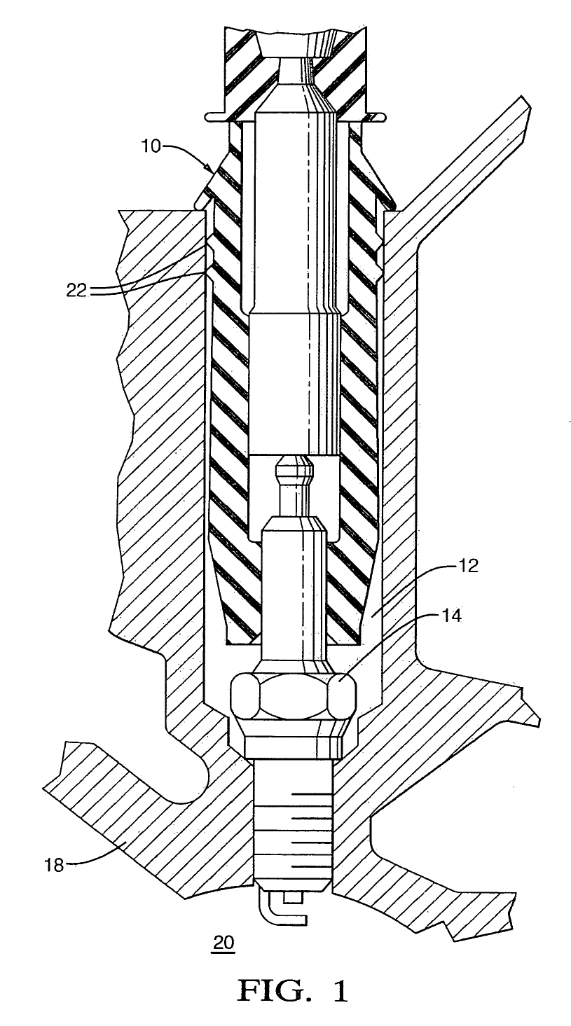

FIG. 1 is a side elevational view showing a spark plug boot 10 in a spark plug well 12 holding a spark plug 14. A spark plug electrical connector 16 takes the place of the top portion of the spark plug 14. Also illustrated is an engine block 18 and an engine cylinder 20 broken away for clarity. The spark plug boot 10 retains the high voltage going from the coil to the spark plug 14 and so must have good dialectic strength and viable interfaces with the coil tower and the spark plug 14. Water exclusion is another functional aspect of the spark plug boot 10.

The spark plug boot 10, whose media may be, but is not limited to, silicon rubber, is comprised of a hollow resilient body defining an interior configured to hold a spark plug. The exterior of the spark plug boot 10 contains one or more sealing rings 22 circumscribing an outer surface of the body and configured for being closely received in a spark plug well 12 of an engine block 18. The exterior of the spark plug boot 10 in the particular illustrations shown contains two sealing rings 22. The sealing rings 22 define a constant diameter around a 360 degree circumference and variable thickness in a dimension parallel to the axis of the rings 22.

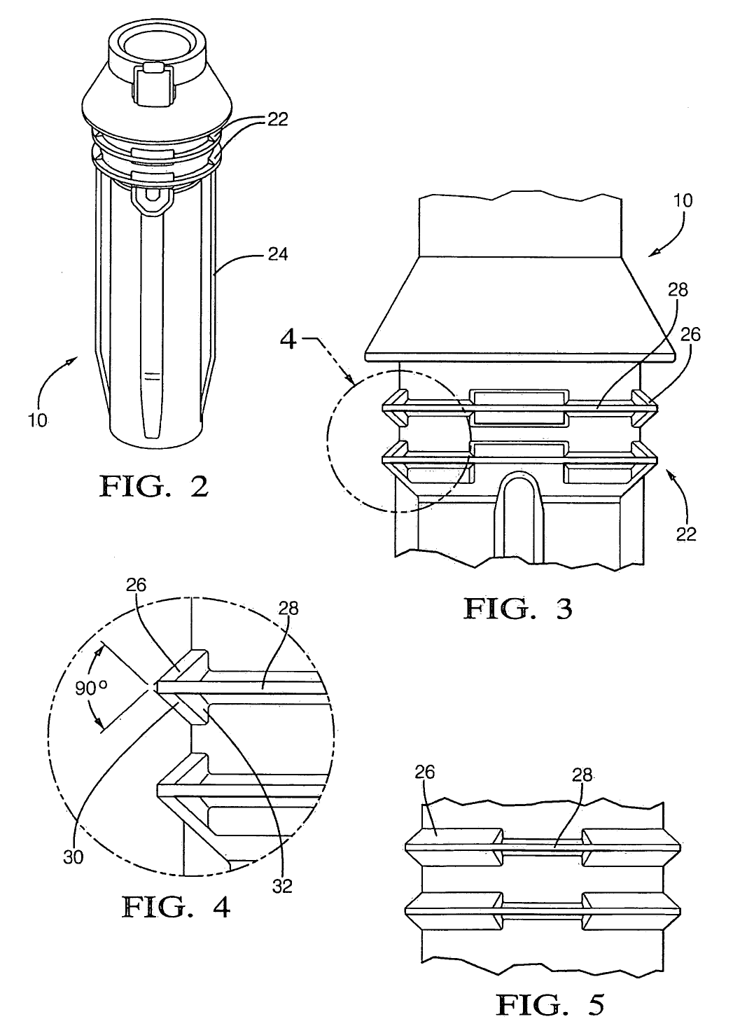

FIG. 2 is a perspective view of an example embodiment of the spark plug boot 10, which may be coated with a lubricant for installation purposes. Two sealing rings 22 are shown; however, more rings may be used to better fit the engine well 12. The sealing rings 22 have a constant outer diameter but have varying thickness. The varying thickness will better exclude water by allowing the spark plug boot 10 to maintain the same metric interference with the spark plug 14. The spark plug boot 10 also has longitudinal ribs 24 that extend from the lower sealing ring to the bottom of the spark plug boot 10. These may effectively provide a uniformly tighter fit for the spark plug boot 10.

FIG. 3 is a side elevational view of the spark plug boot 10 shown in FIG. 2, with portions broken away. In this drawing, it is clearly shown that each of the two sealing rings 22 shown have plural thicker portions 26 separated by respective thinner portions 28. The number, spacing, and arc length of the thicker portions 26 are established as necessary to reduce the insertion force while simultaneously impeding vibration propagation. The thicker portions 26 establish a minor stability to the thinner portions 28 that may move easily during insertion. In non-limiting generality, the number of thicker portions 26 should be equal to or more than two.

FIG. 4 is detail of the rings as seen in the circle “4” in FIG. 3. Each thicker portion 26 is established by two legs 30, upper and lower, that extend from the thinner portion 28 to a connector segment 32 that runs flush against the exterior of the spark plug boot 10. Each connector segment 32 connects a leg 30 with the thinner portion 28. In the non-limiting example shown, each leg 30 lies in a plane about forty five degrees away from the horizontal, either in the positive or negative direction, thereby making the arc length of both legs 30 ninety degrees. The triangular space formed by the legs 30 and connector segments 32 is hollow in this case.

FIG. 5 illustrates a different embodiment in which that space may be filled rather than hollow. To achieve this, the thicker portions 26 may simply be molded to be thicker than the thinner portions 28.

While the particular SPARK PLUG BOOT is herein shown and described in detail, it is to be understood that the subject matter which is encompassed by the present invention is limited only by the claims.

What is claimed is:

1. A spark plug boot comprising:
a hollow resilient body defining an interior configured to hold a spark plug; and
at least one sealing ring circumscribing an outer surface of the body and configured for being closely received in a spark plug well of an engine block, wherein the ring defines a constant diameter around a 360 degree circumference and variable thickness in a dimension parallel to the axis of the ring.

2. The boot of claim 1, comprising at least two rings.

3. The boot of claim 1, wherein the body is made of Silicon.

4. The boot of claim 1, wherein each ring comprises plural thicker portions separated by respective thinner portions.

5. The boot of claim 1, wherein each thicker portion is hollow.

6. The boot of claim 1, wherein each thicker portion is solid.

7. A spark plug boot comprising:
an elongated body configured to hold a spark plug; and
at least one sealing ring circumscribing an outer surface of the body, the ring defining a first thickness and a second thickness different from the first thickness.

8. The boot of claim 7, comprising at least two rings.

9. The boot of claim 7, wherein the body is made of Silicon.

10. The boot of claim 7, wherein each ring comprises plural thicker portions separated by respective thinner portions.

11. The boot of claim 10, wherein each thicker portion is hollow.

12. The boot of claim 10, wherein each thicker portion is solid.

13. Method comprising:
establishing at least one thin ring portion on a spark plug boot in accordance with a predetermined maximum insertion threshold; and
establishing at least one thick ring portion on the boot to inhibit transmission of vibration across the boot to a spark plug held therein.

14. The method of claim 13, comprising at least two rings on the boot.

15. The method of claim 13, wherein the boot is made of Silicon.

16. The method of claim 13, wherein each ring comprises plural thicker portions separated by respective thinner portions.

17. The method of claim 16, wherein each thicker portion is hollow.

18. The method of claim 16, wherein each thicker portion is solid.
